(19) United States
(12) Patent Application Publication
(10) Pub. No.: US 2015/0232678 A1
(43) Pub. Date: Aug. 20, 2015

(54) INK JET AQUEOUS INK AND IMAGE FORMING METHOD

(71) Applicant: CANON KABUSHIKI KAISHA, Tokyo (JP)

(72) Inventors: Taketoshi Okubo, Asaka-shi (JP); Kenichi Iida, Kawasaki-shi (JP); Hiroya Nitta, Yokohama-shi (JP); Akiko Kitao, Kawasaki-shi (JP)

(21) Appl. No.: 14/620,549

(22) Filed: Feb. 12, 2015

(30) Foreign Application Priority Data
Feb. 19, 2014 (JP) 2014-029307

(51) Int. Cl. C09D 11/32

(52) U.S. Cl. CPC C09D 11/32

(57) ABSTRACT

An ink jet aqueous ink including particles of a compound represented by the following general formula (I); a dispersant for dispersing the particles; and water,

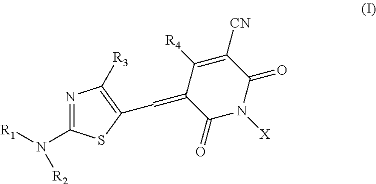

where, in the general formula (I), R₁ and R₂ each independently represent an alkyl group, R₃ represents an alkyl group or an aryl group, R₄ represents an alkyl group, and X represents an alkyl group or a group represented by NR₅R₆, where R₅ and R₆ each independently represent a hydrogen atom, an alkyl group, or an acyl group.

### BACKGROUND OF THE INVENTION

1. Field of the Invention

The present invention relates to an ink jet aqueous ink and an image forming method.

2. Description of the Related Art

In order to represent an image having a metallic color in a recorded article such as an advertising print or a photograph, hitherto, offset printing, gravure printing, screen printing, or the like using an ink containing a metal pigment such as an aluminum pigment or a pearl pigment has been adopted. In recent years, with development of an ink jet recording method, it has been required to develop an aqueous ink that enables recording of an image having a metallic color and can be ejected from a recording head of an ink jet recording system. Aqueous inks containing metal particles of gold, silver, or aluminum have hitherto been proposed (Japanese Patent Application Laid-Open No. 2004-067931, Japanese Patent Application Laid-Open No. 2009-269935, and Japanese Patent Application Laid-Open No. 2010-121141).

### SUMMARY OF THE INVENTION

However, the inks proposed in Japanese Patent Application Laid-Open No. 2004-067931, Japanese Patent Application Laid-Open No. 2009-269935, and Japanese Patent Application Laid-Open No. 2010-121141 may have a problem in long-term storage stability, because the metal particles are liable to settle out owing to their high specific gravity. In addition, the metal particles of aluminum, silver, or the like, which easily cause a change in color in air or water, are used as a pigment, and hence a change in color is liable to occur after printing and an image may have insufficient stability.

Therefore, an object of the present invention is to provide an ink jet aqueous ink that enables recording of an image having a metallic color without using a metal pigment. In addition, another object of the present invention is to provide an image forming method using the ink jet aqueous ink.

The above-mentioned objects are achieved by the present invention described below. That is, an ink jet aqueous ink according to an embodiment of the present invention includes particles of a compound represented by the following general formula (I); a dispersant for dispersing the particles; and water.

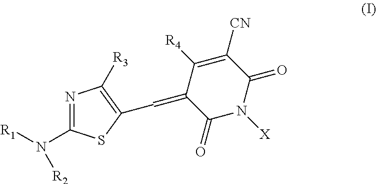

(In the general formula (I), R₁ and R₂ each independently represent an alkyl group, R₃ represents an alkyl group or an aryl group, R₄ represents an alkyl group, and X represents an alkyl group or a group represented by NR₅R₆, where R₅ and R₆ each independently represent a hydrogen atom, an alkyl group, or an acyl group.)

According to an embodiment of the present invention, it is possible to provide the ink jet aqueous ink that enables recording of an image having a metallic color without using a metal pigment. According to another embodiment of the present invention, it is possible to provide an image forming method using the ink jet aqueous ink.

Further features of the present invention will become apparent from the following description of exemplary embodiments.

### DESCRIPTION OF THE EMBODIMENTS

Ink Jet Aqueous Ink

Embodiments of the present invention are hereinafter described, but the present invention is not limited to the embodiments described below. An ink jet aqueous ink (hereinafter also referred to simply as “ink”) of the present invention contains particles of a compound represented by the general formula (I), a dispersant for dispersing the particles, and water. The ink jet aqueous ink of the present invention is hereinafter described in detail.

Compound Represented by General Formula (I)

The ink of the present invention contains the particles of the compound represented by the general formula (I).

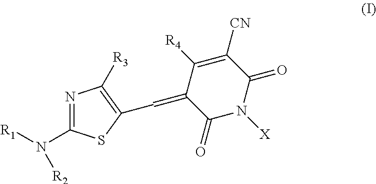

(In the general formula (I), R₁ and R₂ each independently represent an alkyl group, R₃ represents an alkyl group or an aryl group, R₄ represents an alkyl group, and X represents an alkyl group or a group represented by NR₅R₆, where R₅ and R₆ each independently represent a hydrogen atom, an alkyl group, or an acyl group.)

The compound represented by the general formula (I) is a component to be used as an organic coloring matter. Examples of the alkyl group represented by R₁ and R₂ in the general formula (I) may include linear, cyclic, or branched alkyl groups having 1 to 10 carbon atoms. Specific examples of such alkyl group may include a methyl group, an ethyl group, a n-propyl group, an isopropyl group, a n-butyl group, an isobutyl group, a tert-butyl group, a sec-butyl group, a n-pentyl group, a neopentyl group, a n-hexyl group, an isohexyl group, a 3-methylpentyl group, an octyl group, a dodecyl group, a cyclobutyl group, a cyclopentyl group, and a cyclohexyl group.

Examples of the alkyl group represented by R₃ in the general formula (I) may include the same alkyl groups as those exemplified as the alkyl group represented by R₁ and R₂. From the viewpoint of light resistance, R₃ preferably represents a tert-butyl group. In addition, examples of the aryl group represented by R₃ in the general formula (I) may include a phenyl group and a naphthyl group.

It should be noted that the aryl group represented by R₃ may have 1 to 3 substituents arbitrarily selected from an alkyl group, an alkoxy group, and a cyano group. Examples of the alkyl group as the substituent may include the same alkyl groups as those exemplified as the alkyl group represented by R₁ and R₂. In addition, examples of the alkoxy group as the substituent may include linear or branched alkoxy groups having 1 to 10 carbon atoms. Specific examples of such alkoxy group may include a methoxy group, an ethoxy group, a n-propoxy group, an isopropoxy group, a n-butoxy group, an isobutoxy group, a tert-butoxy group, and a sec-butoxy group.

Examples of the alkyl group represented by R₄ in the general formula (I) may include the same alkyl groups as those exemplified as the alkyl group represented by R₁ and R₂. In addition, examples of the acyl group represented by R₅ and R₆ in the general formula (I) may include an alkylcarbonyl group and an arylcarbonyl group. Specific examples of such acyl group may include a formyl group, an acetyl group, a propyonyl group, and a benzoyl group.

Herein, Compounds 1 to 10 are shown below as preferred examples of the general formula (I). However, the general formula (I) is not limited to these compounds.

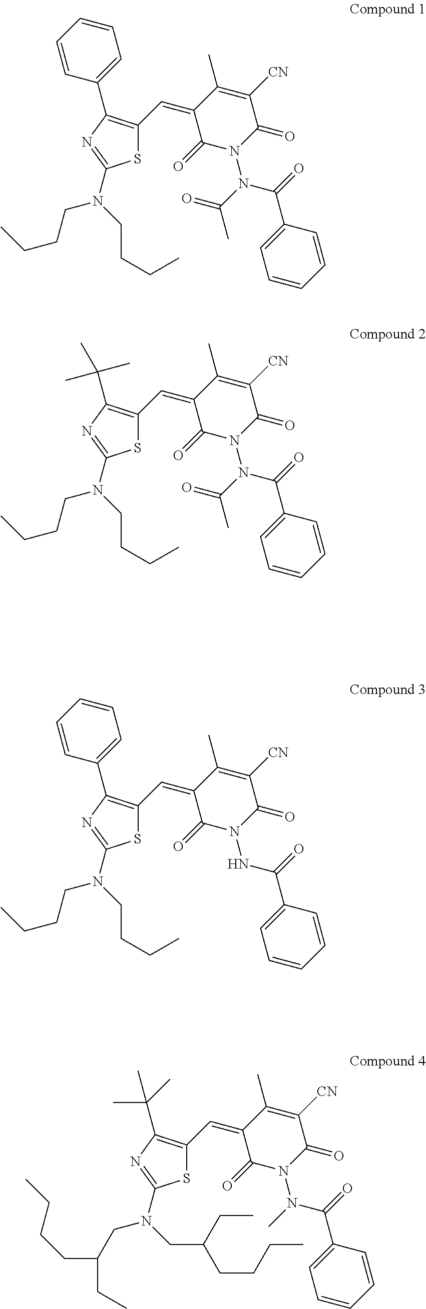

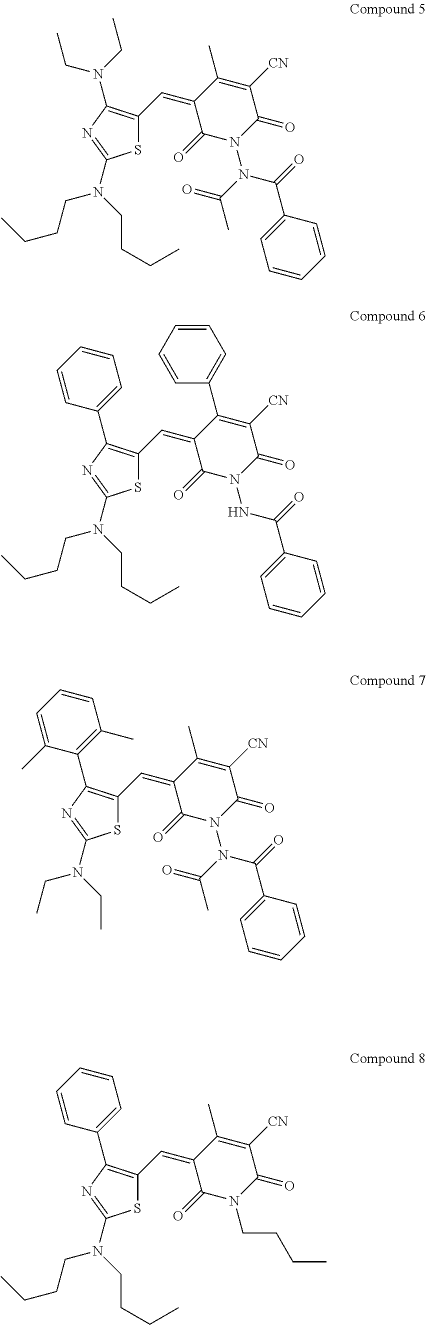

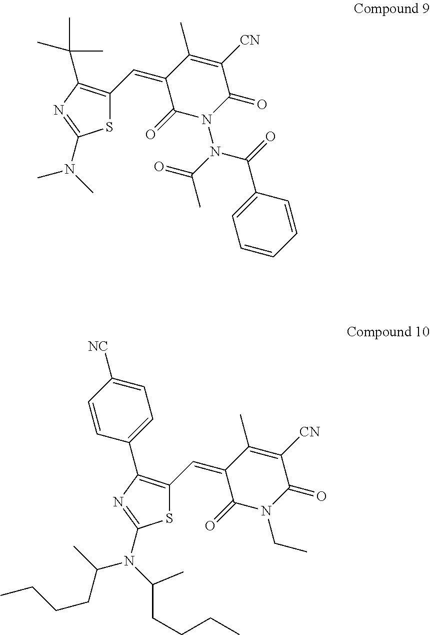

It is preferred that the compound represented by the general formula (I) (organic coloring matter) have a lower molecular weight, because an image to be recorded has a more improved metallic color. The compound represented by the general formula (I) has a molecular weight of preferably 900 or less, more preferably 800 or less, particularly preferably 700 or less. It should be noted that the compound represented by the general formula (I) can be synthesized with reference to the description of Japanese Patent No. 3117712, for example.

The content of the compound represented by the general formula (I) in the ink is preferably 0.5 mass % or more, more preferably 1.0 mass % or more, particularly preferably 2.0 mass % or more with respect to the entire ink. When the content of the compound represented by the general formula (I) is less than 0.5 mass %, an image to be obtained may not have a sufficient metallic color. In addition, the content of the compound represented by the general formula (I) in the ink is preferably 10 mass % or less, more preferably 8.0 mass % or less, particularly preferably 6.0 mass % or less with respect to the entire ink. When the content of the compound represented by the general formula (I) exceeds 10 mass %, ink ejection stability tends to lower.

Particles of Compound Represented by General Formula (I)

The particles contained in the ink of the present invention are formed of a compound represented by the general formula (I). In addition, the particles are dispersed in the ink by a dispersant described later. The particles dispersed in the ink have an average particle size of preferably 5 nm or more, more preferably 10 nm or more, particularly preferably 20 nm or more. In addition, the particles dispersed in the ink have an average particle size of preferably 1,000 nm or less, more preferably 500 nm or less, particularly preferably 200 nm or less. When the average particle size of the particles dispersed in the ink is outside the above-mentioned range, the ink ejection stability from an ink jet head tends to lower. It should be noted that the average particle size of the particles in the present invention means a volume average particle size D₅₀ at which the cumulative value in the particle size distribution reaches 50%. The average particle size can be measured by using, for example, a particle size distribution measuring apparatus of a dynamic light scattering system. For example, a trade name “FPAR-1000” (manufactured by Otsuka Electronics Co., Ltd., cumulant method analysis) and a trade name “UPA-EX150” (manufactured by NIKKISO CO., LTD.) may be used as the particle size distribution measuring apparatus of a dynamic light scattering system. The term “average particle size” as used hereinafter refers to the volume average particle size D₅₀ unless otherwise stated.

Dispersant

The ink of the present invention contains a dispersant capable of stably dispersing the particles of the compound represented by the general formula (I) in the ink. As the dispersant, a low-molecular-weight dispersant or a polymer dispersant may be used. It should be noted that those dispersants may be used in combination.

The low-molecular-weight dispersant is a kind of surfactant having a hydrophilic moiety and a hydrophobic moiety and having a molecular weight of less than 1,000. Examples of the hydrophilic moiety include an anionic group, a cationic group, and a nonionic group. It should be noted that an amphoteric (betaine-type) surfactant, which has an anionic group and a cationic group, may also be used.

The anionic group only needs to be a group that can be negatively charged. Specific examples of the anionic group may include a carboxy group, a sulfonic acid group, a sulfuric acid group, a phosphoric acid group, and a phosphoric acid group. The cationic group only needs to be a group that can be positively charged. Specific examples of the cationic group may include an ammonium group and a pyridinium group. In addition, specific examples of the nonionic group may include polyethylene oxide and a saccharide unit. Of those, an anionic group is preferred as the hydrophilic moiety of the low-molecular-weight dispersant (surfactant). A sulfonic acid group or a carboxy group is more preferred.

The hydrophobic moiety of the low-molecular-weight dispersant (surfactant) is formed of, for example, a hydrocarbon, a fluorocarbon, or a silicone. Of those, the hydrophobic moiety of the low-molecular-weight dispersant is preferably formed of a hydrocarbon. In addition, the hydrophobic moiety of the low-molecular-weight dispersant is more preferably formed of a hydrocarbon having 2 to 24 carbon atoms, particularly preferably formed of a hydrocarbon having 6 to 20 carbon atoms. The structure of the hydrophobic moiety of the low-molecular-weight dispersant may be linear or branched. Further, the structure may be formed of a single chain or two or more chains.

Specific examples of the low-molecular-weight dispersant having an anionic group (anionic surfactant) may include an N-acyl-N-methyltaurine salt, a fatty acid salt, an alkyl sulfate salt, an alkylbenzenesulfonic acid salt, an alkylnaphthalenesulfonic acid salt, a dialkylsulfosuccinic acid salt, an alkyl phosphate salt, a naphthalenesulfonic acid formalin condensate, and a polyoxyethylene alkyl sulfate salt. In addition, a cation of an alkali metal is preferred as a cation for forming the salt. One kind of those anionic surfactants may be used alone, or two or more kinds thereof may be used in combination. Specific examples of the low-molecular-weight dispersant having a cationic group (cationic surfactant) may include a quaternary ammonium salt, an alkoxylated polyamine, an aliphatic amine polyglycol ether, an aliphatic amine, a diamine and polyamine derived from an aliphatic amine and an aliphatic alcohol, imidazoline, which is derived from a fatty acid, and salts thereof.

Specific examples of the nonionic low-molecular-weight dispersant (nonionic surfactant) may include a polyoxyethylene alkyl ether, a polyoxyethylene alkylaryl ether, a polyoxyethylene fatty acid ester, a sorbitan fatty acid ester, a polyoxyethylene sorbitan fatty acid ester, a polyoxyethylene alkylamine, and a glycerin fatty acid ester. Of those, a polyoxyethylene alkylaryl ether is preferred. One kind of those nonionic surfactants may be used alone, or two or more kinds thereof may be used in combination.

The polymer dispersant is a dispersant having a weight average molecular weight of 1,000 or more. A polymer dispersant having an anionic group may suitably be used as the polymer dispersant. Specific examples of the polymer dispersant may include a styrene-acrylic acid copolymer, a styrene-acrylic acid-acrylic acid alkyl ester copolymer, a styrene-maleic acid copolymer, a styrene-maleic acid-acrylic acid alkyl ester copolymer, a styrene-methacrylic acid copolymer, a styrene-methacrylic acid-acrylic acid alkyl ester copolymer, a styrene-maleic acid half ester copolymer, a vinylnaphthalene-acrylic acid copolymer, a vinylnaphthalene-maleic acid copolymer, a styrene-maleic anhydride-maleic acid half ester copolymer, and salts thereof.

The weight average molecular weight of the polymer dispersant is preferably 2,000 or more and 50,000 or less, more preferably 5,000 or more and 25,000 or less, particularly preferably 3,000 or more and 15,000 or less. When a polymer dispersant having a weight average molecular weight outside the above-mentioned range is used, dispersion stability of the particles in the ink tends to lower.

The acid value of the polymer dispersant is preferably 80 mg KOH/g or more, more preferably 100 mg KOH/g or more. When the acid value of the polymer dispersant is less than 80 mg KOH/g, the ink ejection stability tends to lower. In addition, the acid value of the polymer dispersant is preferably 250 mg KOH/g or less, more preferably 200 mg KOH/g or less. When the acid value of the polymer dispersant exceeds 250 mg KOH/g, the polymer dispersant hardly adsorbs onto the compound represented by the general formula (I), and hence the dispersion stability of the particles tends to lower.

As the polymer dispersant, a polyacrylic dispersant or a styrene acrylic dispersant is preferably used, and a styrene-acrylic acid copolymer is more preferably used. As the polyacrylic dispersant, one prepared by a polymerization method heretofore known or a commercially available product may be used.

An example of the commercially available product of the polyacrylic dispersant is a JONCRYL (registered trademark) series (trade name, manufactured by BASF Japan Ltd.). Further specific examples of the JONCRYL series may include as trade names JONCRYL 67 (weight average molecular weight: 12,500, acid value: 213 mg KOH/g), JONCRYL 678 (weight average molecular weight: 8,500, acid value: 215 mg KOH/g), JONCRYL 586 (weight average molecular weight: 4,600, acid value: 108 mg KOH/g), JONCRYL 680 (weight average molecular weight: 4,900, acid value: 215 mg KOH/g), JONCRYL 682 (weight average molecular weight: 1,700, acid value: 238 mg KOH/g), JONCRYL 683 (weight average molecular weight: 8,000, acid value: 160 mg KOH/g), JONCRYL 690 (weight average molecular weight: 16,500, acid value: 240 mg KOH/g), JONCRYL 819 (weight average molecular weight: 14,500, acid value: 75 mg KOH/g), JONCRYL JDX-C3000 (weight average molecular weight: 10,000, acid value: 85 mg KOH/g), and JONCRYL JDX-C3080 (weight average molecular weight: 14,000, acid value: 230 mg KOH/g).

The above-mentioned products of the JONCRYL series are copolymers of (meth)acrylic acid and at least one of a (meth)acrylic acid alkyl ester and a styrene-based monomer. In addition, JONCRYL JDX-C3000 is a copolymer of (meth)acrylic acid and a (meth)acrylic acid alkyl ester. It should be noted that the weight average molecular weight values and the acid values for the JONCRYL series are values from a product brochure.

The content of the dispersant (polymer dispersant and low-molecular-weight dispersant) in the ink is preferably 10 mass % or more, more preferably 20 mass % or more, particularly preferably 30 mass % or more with respect to the compound represented by the general formula (I). When the content of the dispersant is less than 10 mass % with respect to the compound represented by the general formula (I), the dispersion stability of the particles tends to lower. In addition, the content of the dispersant (polymer dispersant and low-molecular-weight dispersant) in the ink is preferably 400 mass % or less, more preferably 300 mass % or less, particularly preferably 200 mass % or less with respect to the compound represented by the general formula (I). When the content of the dispersant exceeds 400 mass % with respect to the compound represented by the general formula (I), an image to be recorded may not have a sufficient metallic color.

Production Method for Particles of Compound Represented by General Formula (I) (Organic Coloring Matter)

In the present invention, the compound represented by the general formula (I) is dispersed in the ink in a particle state. As a production method for the particles of the compound represented by the general formula (I), there are two methods: a top-down method and a bottom-up method. The top-down method is a method involving mechanically crushing coarse particles with a dispersing machine such as a roll mill or a bead mill to make the particles finer. On the other hand, the bottom-up method is a method involving causing particles to aggregate with each other from a solution in which a target compound is dissolved. Particles produced by any of those methods can be preferably used as the particles of the compound represented by the general formula (I). The particles are preferably produced by the bottom-up method, because particles having small particle sizes can be easily produced. As the bottom-up method, an in-liquid drying method, a dissolution-reprecipitation method, a phase-transition emulsification method, and the like are known, and any of those methods may be used.

In the in-liquid drying method, the particles of the compound represented by the general formula (I) are produced as follows: a solution obtained by dissolving the compound represented by the general formula (I) in a water-insoluble or poorly water-soluble organic solvent is mixed with water in the presence of a resin dispersant; the organic solvent is removed from the resultant emulsion; and thus the particles of the compound represented by the general formula (I) are allowed to precipitate in water. In the dissolution-reprecipitation method, the particles of the compound represented by the general formula (I) are produced as follows: a dissolution solution of the compound represented by the general formula (I) in which the compound is dissolved in an organic solvent (hereinafter referred to as “compound-dissolved solution”) is mixed with a solvent having a poor ability to dissolve the compound or with water in the presence of a dispersant; and thus the particles of the compound are allowed to precipitate again in water or the like. Those production methods of the bottom-up method allow the particles of the compound represented by the general formula (I) to be produced under moderate conditions.

An example of the preparation method for the particles to be used in the ink of the present invention is described. First, a first liquid containing the compound represented by the general formula (I) and an organic solvent and a second liquid containing water and a polymer dispersant are prepared. The prepared first liquid and second liquid are mixed to provide an emulsion containing the first liquid as a dispersoid. The dispersoid contains the compound represented by the general formula (I) and the organic solvent, and is dispersed in water by the polymer dispersant. After that, the organic solvent is removed from the dispersoid. Thus, the particles can be obtained in a state of being dispersed and stabilized in water by the polymer dispersant.

In the first liquid, the compound represented by the general formula (I) is preferably in a state of being dissolved in the organic solvent. In addition, in the second liquid, the polymer dispersant is preferably in a state of being dissolved in water. In addition, it is preferred to adjust the pH of the first liquid, the second liquid, or the mixture thereof (emulsion) to a pH around neutral (a pH of from 6 to 10) before or after the mixing of the first liquid and the second liquid, as required. With this, the polymer dispersant easily adsorbs onto the compound represented by the general formula (I), and hence the particles can be obtained in a more dispersed and stabilized state.

The mixing of the first liquid and the second liquid is performed by using, for example, a heretofore known stirring/shearing machine configured to impart mechanical energy, such as a high shear homomixer, an ultrasonic homogenizer, a high pressure homogenizer, or a thin-film spin high speed mixer. Of those, an ultrasonic homogenizer, a high pressure homogenizer, or a thin-film spin high speed mixer is preferably used. Alternatively, the emulsion may be prepared by a method using a microreactor or the like based on an interfacial chemical mechanism, such as a membrane emulsification method utilizing an SPG membrane, a microchannel emulsification method, or a microchannel-branched emulsification method. It should be noted that the emulsion may be prepared by a single stage or by a plurality of stages. In addition, the mass ratio of the first liquid to the second liquid (first liquid/second liquid) is set to preferably 1/20 or more and ⅔ or less, more preferably 1/15 or more and ½ or less, particularly preferably 1/10 or more and ¼ or less.

From the viewpoint of throughput, the organic solvent is preferably removed from the dispersoid by a pressure-reducing process, a dialysis process, or the combination thereof. The pressure-reducing process can be performed by using, for example, a heretofore known pressure-reducing machine such as an evaporator. In addition, the dialysis process can be performed by using, for example, a heretofore known dialysis machine such as an ultrafiltration machine in addition to static dialysis using a semipermeable membrane.

A preferred example of the organic solvent to be used in the first liquid is an organic solvent having a low solubility in water and capable of forming an interface when mixed with water. The solubility of the organic solvent is preferably 3 parts by mass or less with respect to 97 parts by mass of water at 25° C. When an organic solvent having a solubility of 3 parts by mass or less with respect to 97 parts by mass of water at 25° C. is used, the emulsion can be prepared in a good state. In addition, it is preferred to use an organic solvent having a boiling point lower than that of water, because such solvent can be easily removed from the dispersoid in the emulsion. Specific examples of such organic solvent include halogenated hydrocarbons such as dichloromethane, chloroform, chloroethane, dichloroethane, trichloroethane, and carbon tetrachloride; ketones such as acetone, methyl ethyl ketone, and methyl isobutyl ketone; ethers such as tetrahydrofuran, ethyl ether, and isobutyl ether; esters such as ethyl acetate and butyl acetate; and aromatic hydrocarbons such as benzene, toluene, and xylene.

In order to dissolve the polymer dispersant in the ink, it is preferred to use a basic compound to form a salt between an anionic group (for example, an acidic group such as a carboxy group) in the polymer dispersant and a counter cation. The basic compound is not particularly limited as long as the compound can form a salt with the anionic group such as a carboxy group. Specific examples of the basic compound may include organic amines such as a primary amine, a secondary amine, a tertiary amine, and a quaternary ammonium salt; aminoalcohol compounds such as aminomethylpropanol, 2-aminoisopropanol, and triethanolamine; cyclic amines such as morpholine; and inorganic bases such as ammonia water. The amount of the basic compound is preferably equal to or more than the neutralization equivalent of the polymer dispersant. In addition, the amount of the basic compound is more preferably about 1.3 times the neutralization equivalent of the polymer dispersant from the viewpoint of image fixing property.

In addition, in order to facilitate ionic dissociation of the salt of the polymer dispersant, it is preferred to enhance dissolution stability of the polymer dispersant by adding a pH buffer solution to the ink to adjust the pH of the ink. The pH buffer solution is not particularly limited as long as the buffer solution has buffering action of adjusting the pH of the ink to 6.5 or more and 10 or less. A salt to be used for the pH buffer solution may be specifically exemplified by potassium hydrogen phthalate, potassium dihydrogen phosphate, disodium hydrogen phosphate, sodium tetraborate, potassium hydrogen tartrate, sodium hydrogen carbonate, sodium carbonate, tris(hydroxymethyl)aminomethane, and tris(hydroxymethyl)aminomethane hydrochloride. The content of the pH buffer solution in the ink is preferably such an amount that the pH of the ink becomes 6.5 or more and 10 or less from the viewpoints of the durability of a member for forming a recording head and the stability of the ink.

Solvent

The ink jet aqueous ink of the present invention needs to contain water as a solvent because the ink is an aqueous ink. The content (mass %) of water in the ink is preferably mass % or more, more preferably 40 mass % or more, particularly preferably 50 mass % or more with respect to the total mass of the ink. When the content of water is less than 30 mass %, the viscosity of the ink becomes higher, and continuous ejection stability tends to lower. In addition, the content of water in the ink is preferably 95 mass % or less, more preferably 90 mass % or less with respect to the total mass of the ink. When the content of water exceeds 95 mass %, an evaporated component in the ink becomes excessive and sticking is liable to occur in a nozzle of an ink jet head.

In addition, the ink of the present invention may contain a water-soluble organic solvent. As the water-soluble organic solvent, any known solvent generally used for an ink jet ink may be used. Specific examples of the water-soluble organic solvent include a monohydric or polyhydric alcohol, an alkylene glycol having an alkylene group having about 1 to 4 carbon atoms, a polyethylene glycol having a number average molecular weight of about from 200 to 2,000, a glycol ether, and a nitrogen-containing compound. The content (mass %) of the water-soluble organic solvent in the ink is preferably 1.0 mass % or more and 40.0 mass % or less, more preferably 3.0 mass % or more and 30.0 mass % or less with respect to the total mass of the ink.

Other Component

In addition to the above-mentioned components, organic compounds that are solid at normal temperature such as trimethylolethane and trimethylolpropane; and nitrogen-containing compounds such as urea and ethyleneurea may be incorporated into the ink of the present invention as required. In addition to the above-mentioned components, various additives which may also be incorporated into the ink as required are as follows: a surfactant, a pH regulator, an antifoaming agent, a rust preventive, an antiseptic, an anti-mold agent, an antioxidant, a reduction inhibitor, an evaporation accelerator, a chelating agent, a water-soluble resin, and the like.

Physical Properties of Ink

The pH of the ink of the present invention is preferably 6.5 or more from the viewpoint of maintaining storage stability and the dispersion stability of the particles. It should be noted that, when the polymer dispersant is used as the dispersant, the pH of the ink is preferably equal to or higher than the isoelectric point of the polymer dispersant. The surface tension of the ink of the present invention is preferably 20 mN/m or more and 40 mN/m or less, more preferably 25 mN/m or more and 40 mN/m or less from the viewpoint of improving ejection stability from an ink jet head. In addition, the viscosity of the ink of the present invention is preferably 15 mPa·s or less, more preferably 10 mPa·s or less, particularly preferably 5 mPa·s.

Image Forming Method

An image forming method of the present invention includes an ink ejection step of ejecting the above-mentioned ink jet aqueous ink from a recording head of an ink jet system onto a recording medium.

Examples of the recording head of an ink jet system include a recording head of a piezo system utilizing mechanical energy action and a recording head of a thermal system utilizing thermal energy action. In the present invention, a recording head of a thermal system is preferably used. In addition, examples of the recording medium include a permeable recording medium such as plain paper or gloss paper, and a non-permeable recording medium such as a film.

The image forming method of the present invention preferably further includes, prior to the ink ejection step, a step of applying an ink exhibiting a black color so that an area having the ink exhibiting a black color applied thereto at least partly overlaps with an area having the ink jet aqueous ink applied thereto. With such step further included, an image having a more natural metallic color can be obtained. This seems to be because, while, in some cases, the color tint of a metallic image differs from a desired hue (the color tint of specularly reflected light) owing to diffused light generated together with the specularly reflected light, the diffused light can be reduced by preliminarily applying the ink exhibiting a black color. It should be noted that, as a method of applying the ink exhibiting a black color, there may be mentioned a printing system such as gravure printing, flexo printing, offset printing, screen printing, or letterpress printing, or an on-demand compact printing system such as an ink jet system or a laser printing system. Of those, an ink jet system, which allows a black ink to be applied to an arbitrary position, is preferred.

In addition, an effect similar to that in the above-mentioned image forming method can also be achieved by allowing the ink to further contain a dye exhibiting a black color. Specifically, in the image forming method including an ink ejection step of ejecting the ink jet aqueous ink from a recording head of an ink jet system onto a recording medium, the ink jet aqueous ink preferably further contains a dye exhibiting a black color. The reason for this seems to be that the black dye dyes the recording medium before the particles of the compound represented by the general formula (I), and hence the diffused light can be reduced.

Ink Exhibiting Black Color

The ink exhibiting a black color to be used in the present invention is an ink containing a coloring material (pigment or dye) exhibiting a black color on the recording medium. The coloring material exhibiting a black color is specifically a coloring material having absorption in the entire wavelength range of 380 nm or more and 780 nm or less. The coloring material exhibiting a black color preferably exhibits a lightness L* value according to the CIE color system of 25 or less when an image recorded with the ink containing the coloring material is subjected to colorimetry in accordance with a colorimetric system containing no specularly reflected light components using an integrating sphere type spectrophotometric colorimeter equipped with a D50 light source. In addition, the coloring material exhibiting a black color more preferably exhibits a lightness L* value according to the CIE color system of 10 or less. An example of the colorimetric system containing no specularly reflected light components using an integrating sphere type spectrophotometric colorimeter is a specular component excluded (SCE) system using a spectrophotometric colorimeter. The light source to be used in the colorimetry is not limited to the D50 light source. For example, an A light source, a C light source, a D65 light source, an F2 light source, an F6 light source, an F7 light source, an F8 light source, an F10 light source, or an F12 light source may be used, and the light source may be selected depending on the use environment of a recorded article (image) to be obtained.

Carbon black is suitably used when the coloring material exhibiting a black color is a pigment. Any carbon black such as furnace black, lamp black, acetylene black, or channel black may be used. Specifically, for example, commercially available products which can be used are as follows: Raven 7000, Raven 5750, Raven 5250, Raven 5000 ULTRA, Raven 3500, Raven 2000, Raven 1500, Raven 1250, Raven 1200, Raven 1190 ULTRA-II, Raven 1170, and Raven 1255 (all of which are manufactured by Columbian Chemicals Co.); Black Pearls L, Regal 400R, Regal 330R, Regal 660R, Mogul L, Monarch 700, Monarch 800, Monarch 880, Monarch 900, Monarch 1000, Monarch 1100, Monarch 1300, Monarch 1400, Monarch 2000, and Valcan XC-72R (all of which are manufactured by Cabot Corporation); Color Black FW1, Color Black FW2, Color Black FW2V, Color Black FW18, Color Black FW200, Color Black 5150, Color Black 5160, Color Black 5170, Printex 35, Printex U, Printex V, Printex 140U, Printex 140V, Special Black 6, Special Black 5, Special Black 4A, and Special Black 4 (all of which are manufactured by Degussa Co.); and No. 25, No. 33, No. 40, No. 47, No. 52, No. 900, No. 2300, MCF-88, MA600, MA7, MA8, and MA100 (all of which are manufactured by Mitsubishi Chemical Corporation). In addition, carbon black specifically and newly prepared for the present invention may be used. However, the coloring material exhibiting a black color to be used in the present invention is not limited to those carbon blacks, and any carbon black heretofore known may be used. In addition, the coloring material exhibiting a black color is not limited to carbon black, and magnetic fine particles such as magnetite or ferrite, titanium black, or the like may be used as the black pigment.

The black pigment is dispersed in the ink and forms a dispersion of organic coloring matter particles. Examples of the dispersion of organic coloring matter particles include (i) a dispersion using a resin dispersant, (ii) a dispersion using a low-molecular-weight dispersant, and (iii) a self-dispersed dispersion capable of maintaining a dispersion state without a dispersant. In the present invention, any of those dispersions may be adopted. The details of the dispersions described in (i) to (iii) are the same as those in the case of the particles of the organic coloring matter. As a black pigment of the self-dispersed dispersion described in (iii), there may be mentioned, for example, CW-1, CW-2, and CW-3 (manufactured by ORIENT CHEMICAL INDUSTRIES CO., LTD.), and CAB-O-JET200, CAB-O-JET300, and CAB-O-JET400 (manufactured by Cabot Corporation).

The black pigment to be used in the present invention has an average particle size of preferably 10 nm or more, more preferably 20 nm or more. When the particle size is less than 10 nm, an effect of reducing the diffused light may not be sufficiently obtained. In addition, the average particle size is preferably 200 nm or less, more preferably 160 nm or less, still more preferably 130 nm or less. When the particle size exceeds 200 nm, its storage stability in the ink may lower.

In the case where the coloring material exhibiting a black color is a dye, a dye may be used alone or a plurality of dyes may be used as a mixture.

The present invention is hereinafter described in more detail by way of Examples, but the present invention is by no means limited to Examples described below without departing from the gist of the present invention. It should be noted that the expressions “part(s)” and “%” in association with a component amount are by mass, unless otherwise indicated. In addition, the average particle size of the particles of the organic coloring matter was measured with a particle size distribution measuring apparatus of a dynamic light scattering system (trade name: “UPA-EX150”, manufactured by NIKKISO CO., LTD.).

### EXAMPLE 1

Synthesis of Compound 1 100 mg of p-toluenesulfonic acid was added to 20 mL of a toluene solution containing 10 mmol of a compound B represented by the following formula (B), and the temperature was raised to 70° C. Then, 20 mL of a toluene solution containing a compound A represented by the following formula (A) was added dropwise thereto. Next, the mixture was heated and refluxed at 160° C. for 6 hours while being subjected to azeotropic dehydration, to cause a reaction. The resultant was cooled to room temperature, and then was concentrated under reduced pressure. The residue was purified by column chromatography (developing solvent: ethyl acetate/heptane). Thus, a compound 1 represented by the following formula (1) was obtained. Compound 1 thus obtained was subjected to measurement of the ¹H-NMR spectrum with a nuclear magnetic resonance absorption spectrum measurement device. The measurement results are shown below. It should be noted that the chemical shift value δ was expressed by using tetramethylsilane as a reference material. In addition, a reaction scheme is shown below.

¹H-NMR (400 MHz, CDCl₃) : δ (ppm) 0.75-1.10 (6H, m), 1.25-1.80 (8H, m), 2.16 (3H, s), 2.56 (3H, S), 3.40-3.62 (2H, m), 3.75-3.90 (2H, m), 7.25-7.75 (11H, m)

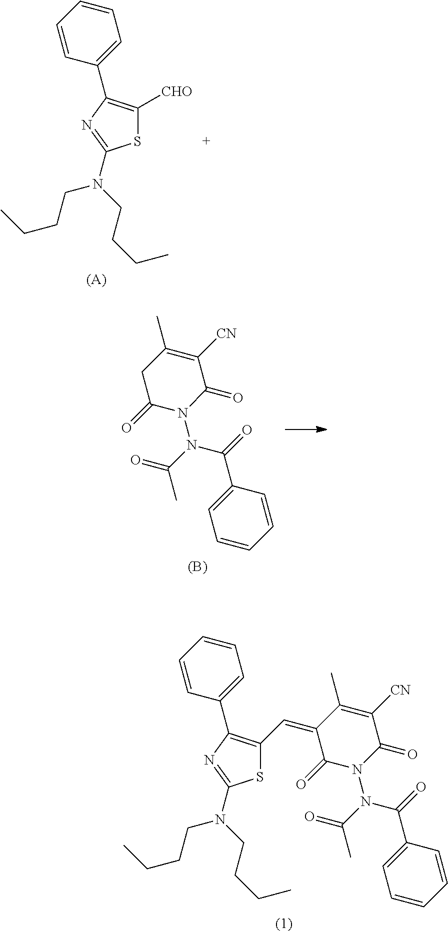

Synthesis of Compounds 4, 5, 6, and 10

Compounds 4, 5, 6, and 10 were synthesized in the same manner as in “Synthesis of Compound 1”.

Preparation of Dispersion 1

Three parts of compound 1 was dissolved in 200 parts of chloroform to provide a mixed solution. On the other hand, a KOH aqueous solution was added to a mixture of 5 parts of a styrene-acrylic acid copolymer (weight average molecular weight: 12,000, acid value: 170 mg KOH/g) and 500 parts of water to adjust the pH to 10. Thus, an aqueous solution of a polymer dispersant was prepared. The above-mentioned mixed solution was added to the prepared aqueous solution of a polymer dispersant, followed by emulsification treatment with an ultrasonic homogenizer for 15 minutes under cooling with ice, to provide an emulsion. Chloroform was distilled away with an evaporator under reduced pressure. Thus, a dispersion 1 was obtained. It was found that particles in the obtained dispersion 1 had an average particle size of 66 nm. It should be noted that the particle size of the particles showed no significant change even after preparation of an ink.

Preparation of Dispersion 2

A dispersion 2 was obtained by dispersing compound 4 in the same manner as in “Preparation of Dispersion 1”. It was found that the average particle size was 34 nm.

Preparation of Dispersion 3

A dispersion 3 was obtained by dispersing compound 5 in the same manner as in “Preparation of Dispersion 1”. It was found that the average particle size was 143 nm.

Preparation of Dispersion 4

A dispersion 4 was obtained by dispersing compound 6 in the same manner as in “Preparation of Dispersion 1”. It was found that the average particle size was 70 nm.

Preparation of Dispersion 5

A dispersion 6 was obtained by dispersing compound 10 in the same manner as in “Preparation of Dispersion 1”. It was found that the average particle size was 35 nm.

Preparation of Ink 1

The following components (total: 100 parts) and the dispersion 1 were mixed so that the concentration of compound 1 in the ink was 5%. The resultant mixture was filtered under pressure with a membrane filter having a pore size of 2.5 pm to obtain an ink 1.

| | |
|---|---|
| Glycerin | 10 parts |
| Acetylenol EH (manufactured by Kawaken Fine Chemicals | 1.0 parts |
| Co., Ltd.) | |
| Ion-exchanged water | balance |

Preparation of Ink 2

An ink 2 was prepared with the dispersion 2 by the same method as that for the ink 1.

Preparation of Ink 3

An ink 3 was prepared with the dispersion 3 by the same method as that for the ink 1.

Preparation of Ink 4

An ink 4 was prepared with the dispersion 4 by the same method as that for the ink 1.

Preparation of Ink 5

An ink 5 was prepared with the dispersion 5 by the same method as that for the ink 1.

Preparation of Ink 6

The following components (total: 100 parts) and the dispersion 1 were mixed so that the concentration of compound 1 in the ink was 5%. The resultant mixture was filtered under pressure with a membrane filter having a pore size of 2.5 pm to obtain an ink 6.

| | | |
|---|---|---|
| BCI-7eBk black dye ink (manufactured by Canon Inc.) | 35 | parts |
| Glycerin | 10 | parts |
| Acetylenol EH (manufactured by Kawaken Fine Chemicals | 1.0 | part |
| Co., Ltd.) | | |

| | |
|---|---|
| Ion-exchanged water | balance |

Preparation of Ink 7

An ink 7 was prepared with the dispersion 2 by the same method as that for the ink 6.

Preparation of Ink 8

An ink 8 was prepared with the dispersion 3 by the same method as that for the ink 6.

Preparation of Ink 9

An ink 9 was prepared with the dispersion 4 by the same method as that for the ink 6.

Preparation of Ink 10

An ink 10 was prepared with the dispersion 5 by the same method as that for the ink 6.

Recording of Image (1)

An ink jet recording apparatus (trade name: “F930” manufactured by Canon Inc., recording head: six ejection orifice rows (each including 512 nozzles), amount of the ink: 4.0 pL (fixed amount), maximum resolution: 1,200 dpi (width)×1,200 dpi (length)) was prepared. The prepared inks 1 to 5 were charged into the ink jet recording apparatus, and a solid image measuring 1 cm×1 cm was printed on a sheet of photo paper for ink jet (trade name: “Canon Photo Paper-Gloss Professional PR-201”, manufactured by Canon Inc.). The printed portion was visually observed and found to be an image showing specularly reflected light of the following metallic color.
Specularly reflected light of the image produced by ejecting the ink 1: metallic yellow (gold)
Specularly reflected light of the image produced by ejecting the ink 2: metallic yellow (gold)
Specularly reflected light of the image produced by ejecting the ink 3: metallic green
Specularly reflected light of the image produced by ejecting the ink 4: metallic yellow (gold)
Specularly reflected light of the image produced by ejecting the ink 5: metallic red

Recording of Image (2)

F930 (manufactured by Canon Inc., recording head: six ejection orifice rows each including 512 nozzles, amount of the ink: 4.0 pL (fixed amount), maximum resolution: 1,200 dpi (width)×1,200 dpi (length)) was used in image formation. A commercially available black dye ink BCI-7eBk (manufactured by Canon Inc.) and the inks 1 to 5 were charged into ink cartridges of F930. Then, a solid image measuring 3 cm×3 cm was printed with the black ink on a sheet of photo paper for ink jet (Canon Photo Paper-Gloss Professional PR-201) as a recording medium. After that, a solid image measuring 3 cm×3 cm was printed with the inks 1 to 5 on the area on which printing had been performed with the black ink.

Printing Evaluation

The images formed in “Recording of Image-1” had an unnatural metallic color, because the specularly reflected light showed a metallic color but the diffused light other than the specularly reflected light showed a color tint different from that of the specularly reflected light. All the images formed by the recording method described in “Recording of Image (2)” using the inks 1 to 5 were images having a natural metallic color with the same specularly reflected light as in the images formed in “Recording of Image (1)” and with reduced diffused light.

Recording of Image-3

Solid images measuring 1 cm×1 cm were printed by using the inks 6 to 10 in the same manner as in “Recording of Image (1)”. The printed portions were visually observed, and it was found that all the images formed by using the inks 6 to 10 were images having a natural metallic color with the same specularly reflected light as in the images formed in “Recording of Image (1)” and with reduced diffused light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-029307, filed Feb. 19, 2014, which is hereby incorporated by reference herein in its entirety.

What is claimed is:

1. An ink jet aqueous ink comprising particles of a compound represented by the following general formula (I);
a dispersant for dispersing the particles; and water, 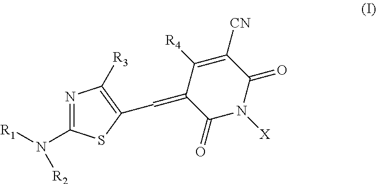
where, in the general formula (I), R₁ and R₂ each independently represent an alkyl group, R₃ represents an alkyl group or an aryl group, R₄ represents an alkyl group, and X represents an alkyl group or a group represented by NR₅R₆, where R₅ and R₆ each independently represent a hydrogen atom, an alkyl group, or an acyl group.

2. An ink jet aqueous ink according to claim 1, wherein the particles have an average particle size of 10 nm or more and 500 nm or less.

3. An image forming method, comprising an ink ejection step of ejecting the ink jet aqueous ink according to claim 1 from a recording head of an ink jet system onto a recording medium.

4. An image forming method according to claim 3, further comprising, prior to the ink ejection step, a step of applying an ink exhibiting a black color so that an area having the ink exhibiting a black color applied thereto at least partly overlaps with an area having the ink jet aqueous ink applied thereto.

5. An image forming method comprising an ink ejection step of ejecting the ink jet aqueous ink according to claim 1 from a recording head of an ink jet system onto a recording medium, wherein the ink jet aqueous ink further comprises a dye exhibiting a black color.
